(19) United States
(12) Patent Application Publication
(10) Pub. No.: US 2016/0149195 A1
(43) Pub. Date: May 26, 2016

(54) CONDUCTIVE MEMBER, AND METHOD OF MANUFACTURING CONDUCTING MEMBER

(71) Applicant: NHK SPRING CO., LTD., Kanagawa (JP)

(72) Inventors: Yuichiro Yamauchi, Kanagawa (JP); Masaru Akabayashi, Kanagawa (JP); Shinya Miyaji, Kanagawa (JP)

(21) Appl. No.: 14/903,414

(22) PCT Filed: Jun. 26, 2014
(86) PCT No.: PCT/JP2014/067069

§ 371 Date: Jan. 7, 2016

(30) Foreign Application Priority Data
Jul. 8, 2013 (JP) 2013-143031

(51) Int. Cl. H01M 2/30; C23C 24/08; H01M 2/20

(52) U.S. Cl. CPC H01M 2/30; H01M 2/206; C23C 24/087

(57) ABSTRACT

A conductive member includes: a conductive member main body portion that has Vickers hardness equal to or greater than 100Hv and is made of copper or a copper alloy; and a film layer that is formed on an end face of the conductive member main body portion and is made of aluminum or an aluminum alloy. The film layer is formed by accelerating a powder material of aluminum or an aluminum alloy together with a gas heated to a temperature lower than a melting point of the powder material, spraying the powder material still remaining in a solid phase onto an end face of the conductive member main body portion, and causing the powder material to be deposited thereon.

### FIELD

The present invention relates to a conductive member, and a method of manufacturing the conductive member.

### BACKGROUND

In recent years, secondary batteries are used as power sources for various purposes, and for purposes requiring large electric power, such as for automobiles or power sources for electric power storage, by connecting plural batteries to one another via conductive members called bus bars, the secondary batteries are used as electric power for large-scale power sources.

A bus bar has been disclosed (see, Patent Literature 1, for example), which is obtained, in order to improve electric resistance and adhesiveness between a secondary battery and an electrode terminal, by connecting aluminum and copper clad materials, or aluminum and copper materials, by cold spraying.

Compound material bus bars have excellent adhesiveness because positive electrodes (aluminum) are connected to aluminum end portions, and negative electrodes (copper) are connected to copper end portions, respectively by laser welding or the like, but since connection conditions of the positive electrodes and the negative electrodes are different from each other, compound material bus bars have had a problem that the number of steps therefor are increased.

As a technique for solving this problem, a method has been adopted, in which a copper plate is swaged on a positive electrode (aluminum) and connection processes between respective end portions of a copper made bus bar and the positive and negative electrodes are done at the same time. However, this method has had a problem that the electrode terminal swaged with the copper plate has a large contact resistance, and weight reduction is difficult to be achieved due to the use of the copper made bus bar.

### CITATION LIST

### Patent Literature

Patent Literature 1: Japanese Patent Application Laid-open No. 2012-144759

### SUMMARY

### Technical Problem

The present invention has been made in view of the above, and an object thereof is to provide: a conductive member, which enables connection processes of positive electrodes and negative electrodes to be done at the same time when secondary batteries are connected to each other via an aluminum made bus bar, and which also has excellent electric resistance and adhesiveness; and a method of manufacturing the conductive member.

### Solution to Problem

To solve the problem and achieve the object, a conductive member according to the present invention includes: a conductive member main body portion that has Vickers hardness equal to or greater than 100Hv and is made of copper or a copper alloy; and a film layer that is formed on an end face of the conductive member main body portion and is made of aluminum or an aluminum alloy, and the film layer is formed by accelerating a powder material of aluminum or an aluminum alloy together with a gas heated to a temperature lower than a melting point of the powder material, spraying the powder material still remaining in a solid phase onto an end face of the conductive member main body portion, and causing the powder material to be deposited thereon.

Moreover, in the above-described conductive member according to the present invention, the conductive member is used as an electrode terminal for a battery.

Moreover, in the above-described conductive member according to the present invention, the conductive member is used as a negative terminal for a battery, the negative terminal being connected to a positive terminal of another battery via an aluminum made bus bar.

Moreover, a method of manufacturing a conductive member according to the present invention includes a step of forming a film layer by: accelerating, towards an end surface of a conductive member main body portion having Vickers hardness equal to or greater than 100Hv and made of copper or a copper alloy, a powder material of aluminum or an aluminum alloy together with a gas heated to a temperature lower than a melting point of the powder material; spraying the powder material still remaining in a solid phase onto the end face of the conductive member main body portion; and causing the powder material to be deposited thereon.

Moreover, the above-described method of manufacturing a conductive member according to the present invention includes, after the formation of the film layer, an annealing step of making the Vickers hardness of the conductive member main body portion to 60 to 80Hv.

### Advantageous Effects of Invention

A conductive member and a method of manufacturing the conductive member according to the present invention are able to: improve adhesion strength between a conductive member main body and a film layer; provide excellent adhesiveness with a bus bar and excellent electric resistance, upon use as an electrode of a battery; simplify steps for manufacturing the battery; and achieve weight reduction of the battery.

### BRIEF DESCRIPTION OF DRAWINGS

FIG. 1 is a schematic diagram illustrating a configuration of a conductive member according to an embodiment of the present invention.

FIG. 2 is a schematic diagram of a secondary battery using the conductive member according to the embodiment of the present invention.

FIG. 3 is a top view illustrating connection, via an aluminum-made bus bar, between the secondary batteries using the conductive members according to the embodiment of the present invention.

FIG. 4 is a schematic diagram illustrating an outline of a cold spray apparatus used in manufacture of the conductive member according to the embodiment of the present invention.

FIG. 5 illustrates a schematic diagram of a test by a simple tensile test method.

FIG. 6 is a diagram illustrating a relation between hardnesses of copper plates and adhesion strengths of aluminum film layers, according to the simple tensile test method.

### DESCRIPTION OF EMBODIMENTS

Hereinafter, a mode for carrying out the present invention will be described in detail, together with the drawings. The present invention is not limited by the following embodiment. Further, each drawing referred to in the following description schematically illustrates shapes, sizes, and positional relations merely to an extent that allows contents of the present invention to be understood. That is, the present invention is not limited only to the shapes, sizes, and positional relations exemplified by each drawing.

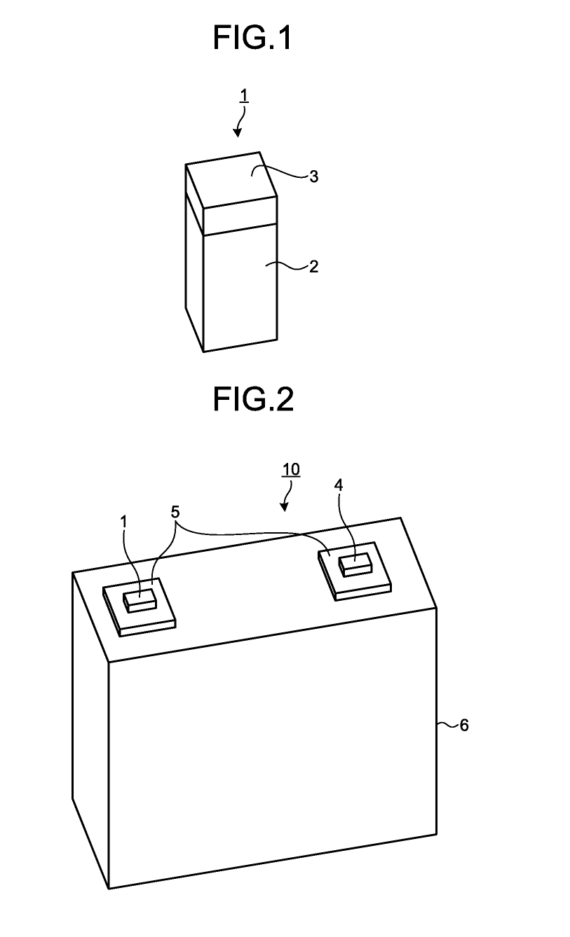

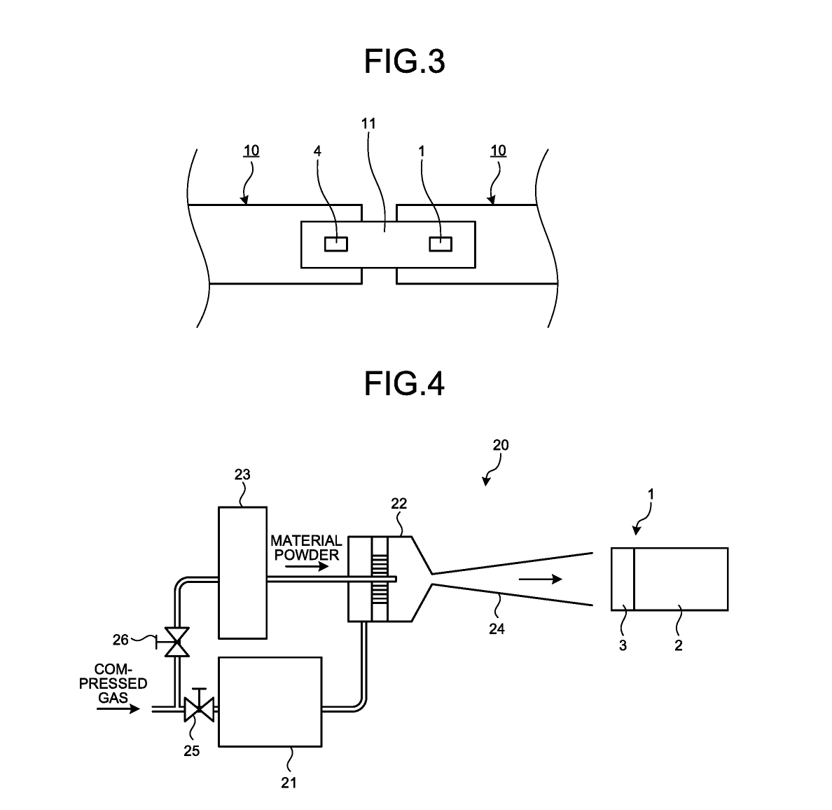

First, a method of manufacturing a conductive member according to the embodiment of the present invention will be described in detail with reference to the drawings. FIG. 1 is a schematic diagram illustrating a structure of the conductive member according to the embodiment of the present invention. FIG. 2 is a schematic diagram of a secondary battery using the conductive member according to the embodiment of the present invention. FIG. 3 is a top view illustrating connection, via an aluminum-made bus bar, between the secondary batteries using the conductive members according to the embodiment of the present invention.

A conductive member 1 is formed of: a conductive member main body portion 2, which has a Vickers hardness equal to or greater than 100 (Hv) and is made of copper or a copper alloy; and a film layer 3, which is layered by later described cold spraying on an end face of the conductive member main body portion 2 and is made of aluminum or an aluminum alloy.

The conductive member main body portion 2 is preferably pure copper, in order to reduce electric resistance of the conductive member 1. Further, copper or the copper alloy, which is the material forming the conductive member main body portion 2, has the Vickers hardness equal to or greater than 100 (Hv). By the use of the copper or copper alloy having the Vickers hardness equal to or greater than 100 (Hv), adhesiveness between the conductive member main body portion 2 and the film layer 3 is able to be improved.

The material used for the conductive member main body portion 2 may be any copper or copper alloy with the Vickers hardness equal to or greater than 100 (Hv), and for example, copper with a temper designation of ¾H or H may be used. Further, if the hardness of the copper or copper alloy of the conductive member main body portion 2 is less than 100, by formation of a copper film by copper plating or cold spraying, hardness of copper on the surface may be increased. In this embodiment, the conductive member 1 has a rectangular column shape but limitation is not made thereto.

The film layer 3 is a film, which is formed on the end face (any one of top and bottom surfaces) of the conductive member main body portion 2 having a rectangular column shape, and which is made of aluminum or the aluminum alloy. The film layer 3 is formed by the later described cold spraying. Generally, when the film layer 3 is formed on a substrate (the conductive member main body portion in this embodiment) formed of a metal or an alloy by cold spraying, by impingement of a material powder to be the film upon the substrate at high velocity, plastic deformation is caused between the material powder and the substrate, and bonding between the film and the substrate is regarded as being obtained due to the anchor effect and metallic bonding. Therefore, since plastic deformation is more likely to be caused for a material with a smaller substrate hardness than for a harder material, the inventors have confirmed that the material with the smaller substrate hardness improves adhesion strength at a boundary surface between the substrate and the film (Japanese Patent Application Laid-open No. 2012-219304). However, the inventors have found that when aluminum, an aluminum alloy, or the like is used as a material of a cold spray material and cold spraying is performed on a substrate made of copper or a copper alloy, the larger the hardness of the copper or copper alloy, which is the substrate, is, the more improved the adhesion strength at the boundary surface between the substrate (copper) and the film (aluminum) is. This is assumed to be because when a material with a large hardness is used as a substrate, an oxide film formed on a surface of the aluminum or aluminum alloy is removed upon spraying and impingement, and metallic bonds with the copper or copper alloy, which is the material of the substrate, tend to be generated.

The conductive member 1 according to this embodiment is able to be used as a negative terminal of a secondary battery 10, as illustrated in FIG. 2. The secondary battery 10 illustrated in FIG. 2 has a nonaqueous electrolyte filled in an outer container 6 thereof in a liquid-tight manner, and has a wound structure in a state where a separator is interposed between a positive plate and a negative plate.

The conductive member 1 used as the negative terminal is installed such that a film layer 3 side thereof protrudes outside the outer container 6, and a positive terminal 4 made of aluminum or an aluminum alloy is also installed such that one end portion thereof protrudes outside the outer container 6, similarly to the conductive member 1. Insulators 5 are respectively arranged between the conductive member 1 and the outer container 6, and between the positive terminal 4 and the outer container 6. The conductive member 1 is connected to the negative plate and the positive terminal 4 is connected to the positive plate, respectively. The connection between the respective terminals and the electrode plates is performed by swaging, welding, or the like, and when the connection is performed by swaging, the conductive member 1 is preferably subjected to annealing. Since a copper material having a large hardness (equal to or greater than 100Hv) is used for the conductive member main body portion 2 according to this embodiment, by annealing under vacuum at 200 to 400° C. to reduce the hardness to about 60 to 80Hv, swaging is able to be performed easily.

When the secondary battery according to this embodiment is connected to be used as electric power for a large power source, as illustrated in FIG. 3, the conductive member 1 used as the negative terminal thereof is connected to a positive terminal 4 of another secondary battery 10 via an aluminum made bus bar 11. The connection between an end portion of the aluminum made bus bar 11 and the conductive member 1 having the film layer 3 made of aluminum or the aluminum alloy, and the connection between the other end portion of the aluminum made bus bar 11 and the positive terminal 4 made of aluminum or the aluminum alloy are able to be achieved under the same condition, for example, by the same laser welding for aluminum connection, or the like. Therefore, by using the same connection material, the connections are able to be performed at the same time. Further, since the aluminum made bus bars 11 are used, a total weight of the battery is able to be reduced remarkably, as compared with a case where copper made bus bars are used. Furthermore, since for the conductive member 1 according to this embodiment, the film layer 3 is formed by cold spraying, as compared with a positive terminal formed by swaging a copper plate with an aluminum made conductive member, the conductive member 1 has an effect of being able to remarkably reduce resistance at the boundary surface between the conductive member main body portion 2 and the film layer 3.

Next, formation of the film layer 3 on the end face of the conductive member main body portion 2 will be described with reference to FIG. 4. FIG. 4 is a schematic diagram illustrating an outline of a cold spray apparatus 20 used in the formation of the film layer 3.

The cold spray apparatus 20 includes: a gas heater 21 that heats up a compressed gas; a powder supply apparatus 23 that houses a material powder to be sprayed onto the conductive member main body portion 2, which is a substrate, and supplies the material powder to a spray gun 22; and a gas nozzle 24, through which the material powder mixed with the compressed gas heated in the spray gun 22 is sprayed onto the substrate.

Helium, nitrogen, air, or the like is used as the compressed gas. The compressed gas to be supplied is supplied to the gas heater 21 and the powder supply apparatus 23 through valves 25 and 26, respectively. After the compressed gas supplied to the gas heater 21 is heated up to a temperature, for example, equal to or higher than 50° C. and equal to or lower than the melting point of aluminum or the aluminum alloy, which is the material powder of the film layer 3, the compressed gas is supplied to the spray gun 22. The compressed gas is preferably heated up to a temperature of 150 to 350° C.

The compressed gas supplied to the powder supply apparatus 23 supplies the material powder, which: is in the powder supply apparatus 23; has a particle diameter of, for example, about 10 to 100 μm; and is made of aluminum or the aluminum alloy, to the spray gun 22 at a predetermined discharge rate. The heated compressed gas is made into a supersonic flow (of about 340 m/s or more) through the gas nozzle 24 having a convergent-divergent shape. Further, a gas pressure of the compressed gas is preferably about 1 to 5 MPa. By setting the pressure of the compressed gas to about 1 to 5 MPa, the adhesion strength between the conductive member main body portion 2 and the film layer 3 is able to be improved. The process is preferably performed under a pressure of about 2 to 4 MPa. The material powder supplied to the spray gun 22 is accelerated through introduction into the supersonic flow of this compressed gas to impinge on the substrate at high velocity, while remaining in the solid phase, to form the film. Any apparatus, which is able to form the film layer 3 by causing the material powder made of aluminum or the aluminum alloy to impinge, in the solid phase, on the conductive member main body portion 2, may be used, not being limited to the cold spray apparatus 20 in FIG. 4.

### Examples

Aluminum particles (A1050 with a particle diameter of 30 μm) were sprayed with a compressed gas of nitrogen, a compressed gas temperature of 250° C., and a gas pressure of 5 MPa, onto copper plates 7 having different hardnesses from one another (C1020, 50 mm×50 mm×3 mm) by use of the cold spray apparatus 20, to form aluminum films 8 of a thickness of 700 μm to thereby obtain test pieces 9.

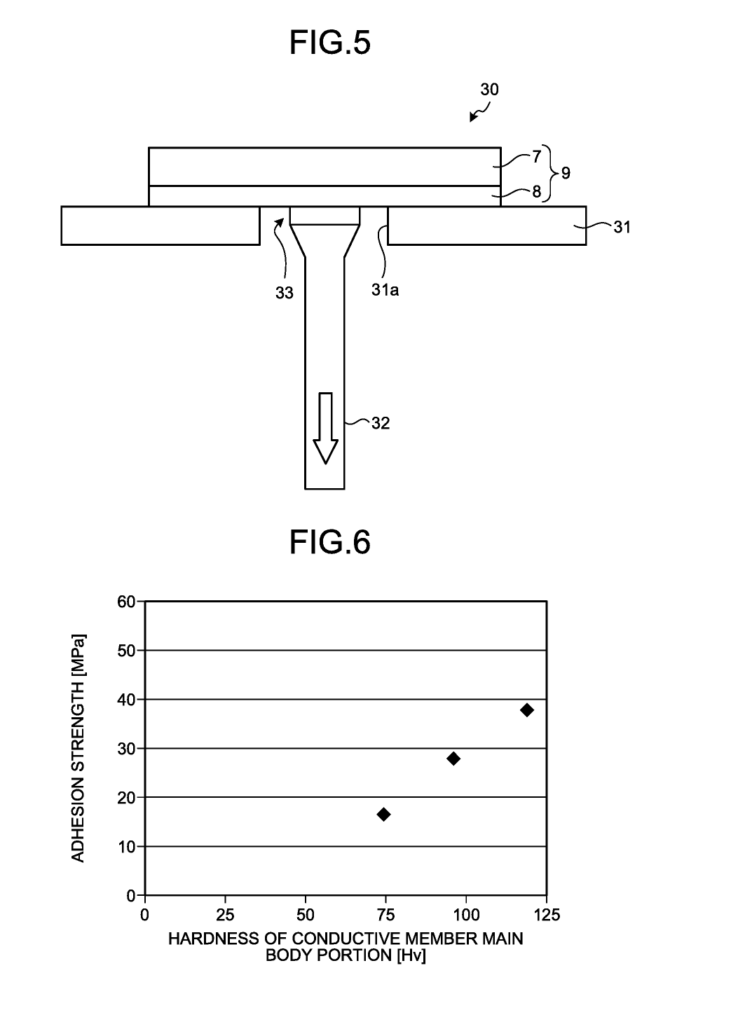

For the test pieces 9 made in the above described manner, adhesion strengths between the copper plates 7 and the aluminum films 8 were evaluated by a tensile strength test method. FIG. 5 illustrates a schematic diagram of a test by a simple tensile test method applied to these examples. In this method, after an aluminum pin 32 was bonded, via an adhesive 33, to the aluminum film 8 formed on the copper plate 7, and the aluminum pin 32 bonded with the aluminum film 8 via the adhesive 33 was inserted into a hole portion 31a of a fixing stage 31 from above, the aluminum pin 32 was pulled downward, to thereby evaluate the adhesion strength between the copper plate 7 and the aluminum film 8. The evaluation was made based on a tensile stress and a peeled state at a time point when the bonding was peeled. Table 1 below lists Vickers hardnesses (Hv) and results of the evaluation of the tensile test according to the differences among tempers of the copper plates 7. Further, FIG. 6 illustrates a relation between the hardnesses of the copper plates the adhesion strengths of the aluminum films. The Vickers hardnesses of the copper plates 7 were measured by FM-ARS6000 manufactured by Future-Tech Corp.

TABLE 1

| | | Vickers Hardness | Adhesion Strength |
|---|---|---|---|
| Material | Temper | [Hv] | [MPa] |
| C1020 | ¼H | 74.7 | 17 |
| | ½H | 96.3 | 28 |
| | H | 119 | 38 |

As listed and illustrated in Table 1 and FIG. 6, it was found that the higher the hardness of the copper plate 7, which is the substrate, was, the higher the adhesion strength at the boundary surface between the copper plate 7 and the aluminum film 8 became.

### INDUSTRIAL APPLICABILITY

As described above, the conductive member and the method of manufacturing the conductive member according to the present invention are useful for a terminal of a battery for a large power source.

### REFERENCE SIGNS LIST

1 CONDUCTIVE MEMBER
2 CONDUCTIVE MEMBER MAIN BODY PORTION
3 FILM LAYER
4 POSITIVE TERMINAL
5 INSULATOR
6 OUTER CONTAINER
7 COPPER PLATE
8 ALUMINUM FILM
9 TEST PIECE
10 SECONDARY BATTERY
11 ALUMINUM MADE BUS BAR
20 COLD SPRAY APPARATUS
21 GAS HEATER
22 SPRAY GUN
23 POWDER SUPPLY APPARATUS
24 GAS NOZZLE
30 TENSILE TEST APPARATUS
31 FIXING STAGE
31a HOLE PORTION
32 ALUMINUM PIN
33 ADHESIVE

1. A conductive member comprising:
a conductive member main body portion that has Vickers hardness equal to or greater than 100Hv and is made of copper or a copper alloy; and
a film layer that is formed on an end face of the conductive member main body portion and is made of aluminum or an aluminum alloy, wherein
the film layer is formed by accelerating a powder material of aluminum or an aluminum alloy together with a gas heated to a temperature lower than a melting point of the powder material, spraying the powder material still remaining in a solid phase onto an end face of the conductive member main body portion, and causing the powder material to be deposited thereon.

2. The conductive member according to claim 1, wherein the conductive member is used as an electrode terminal for a battery.

3. The conductive member according to claim 1, wherein the conductive member is used as a negative terminal for a battery, the negative terminal being connected to a positive terminal of another battery via an aluminum made bus bar.

4. A method of manufacturing a conductive member, the method including a step of forming a film layer by:
accelerating, towards an end surface of a conductive member main body portion having Vickers hardness equal to or greater than 100Hv and made of copper or a copper alloy, a powder material of aluminum or an aluminum alloy together with a gas heated to a temperature lower than a melting point of the powder material;
spraying the powder material still remaining in a solid phase onto the end face of the conductive member main body portion; and
causing the powder material to be deposited thereon.

5. The method of manufacturing the conductive member according to claim 4, the method including, after the formation of the film layer, an annealing step of making the Vickers hardness of the conductive member main body portion to 60 to 80Hv.

6. An electrode terminal for a battery, comprising:
a conductive member including:
a conductive member main body portion that has Vickers hardness equal to or greater than 100Hv and is made of copper or a copper alloy; and
a film layer that is formed on an end face of the conductive member main body portion and is made of aluminum or an aluminum alloy,
wherein the film layer is formed by accelerating a powder material of aluminum or an aluminum alloy together with a gas heated to a temperature lower than a melting point of the powder material, spraying the powder material still remaining in a solid phase onto an end face of the conductive member main body portion, and causing the powder material to be deposited thereon.

7. The electrode terminal according to claim 6, wherein the electrode terminal is a negative terminal that is connected to a positive terminal of another battery via an aluminum made bus bar.
